(19) United States
(12) Patent Application Publication
(10) Pub. No.: US 2024/0334901 A1
(43) Pub. Date: Oct. 10, 2024

(54) FEED MANAGEMENT SERVICE PROVISION DEVICE AND METHOD

(71) Applicant: AIMBE LAB INC., Seongnam-si (KR)

(72) Inventor: Byung Soo GO, Yongin-si (KR)

(21) Appl. No.: 18/744,743

(22) Filed: Jun. 17, 2024

Related U.S. Application Data
(63) Continuation-in-part of application No. PCT/KR2022/019579, filed on Dec. 5, 2022.

(30) Foreign Application Priority Data
Dec. 17, 2021 (KR) 10-2021-0181394

(51) Int. Cl. A01K 5/02; G01F 23/292; G01F 23/80

(52) U.S. Cl. CPC A01K 5/0275; G01F 23/292; G01F 23/804

(57) ABSTRACT

Disclosed are a feed management service provision device and method. A feed management service provision device for providing a feed management service in connection with a measurement device installed inside a feed bin in a farmhouse, according to one embodiment of the present invention, comprises: a communication unit receiving, from the measurement device, a feed distance measurement value representing the distance between the measurement device and the feed, and environment data on the environment inside the feed bin; an error correction model training unit for training an error correction model using a plurality of pieces of training data collected from a plurality of feed bins, including a plurality of feed distance measurement values for training, a plurality of pieces of environment data for training, and a plurality of actual feed distance values corresponding to the plurality of feed distance measurement values for training; an error correction unit for calculating an error-corrected feed distance measurement value using the error correction model that has been trained and the feed distance measurement values and the environment data received from the communication unit; a residual feed amount calculation unit for calculating the residual amount of feed on the basis of the error-corrected feed distance measurement value and feed bin-related information; and a feed management service provision unit for providing a feed management service to a user device on the basis of the residual amount of feed.

### TECHNICAL FIELD

The present invention relates to a technology for providing a feed management service.

### BACKGROUND ART

A technology for managing feed includes a load cell method of measuring the weight of a feed bin and a laser method of measuring the distance from the inside of the feed bin to the feed. The load cell method has a problem of frequent breakdowns due to excessive application of the load of the feed bin. The laser method has problems of requiring various facilities, periodic horizontal level check, and inaccurate information when the laser scatters.

Therefore, in general farmhouses, there is a need for technology for accurately measuring the remaining amount of feed in the feed bin and managing the feed efficiently.

### DISCLOSURE

### Technical Problem

Embodiments of the present invention are directed to providing a device and method for providing a feed management service in consideration of the remaining amount of feed and a spoilage degree of the feed.

### Technical Solution

According to one embodiment of the present invention, a feed management service provision device that provides a feed management service in conjunction with a measurement device installed inside a feed bin of a farmhouse includes a communication unit configured to receive a feed measurement distance value indicating a distance from the measurement device to feed and environment data inside the feed bin from the measurement device, an error correction model training unit configured to train an error correction model using a plurality of pieces of training data including a plurality of feed measurement distance values for training collected from a plurality of feed bins, a plurality of pieces of environment data for training, and a plurality of actual feed distance values corresponding to the plurality of feed measurement distance values for training, an error correction unit configured to calculate an error-corrected feed measurement distance value from the feed measurement distance value and the environment data received by the communication unit using the trained error correction model, a feed remaining amount calculation unit configured to calculate a remaining amount of the feed based on the error-corrected feed measurement distance value and information related to the feed bin, and a feed management service provision unit configured to provide a feed management service to a user device based on the remaining amount of the feed.

The error correction model training unit may receive the plurality of feed measurement distance values for training and the plurality of pieces of environment data for training and train the error correction model to output distance values that are close to the plurality of actual feed distance values.

The error correction model may be trained in a manner of outputting distance values by receiving the feed measurement distance values for training and the pieces of environment data for training, and updating weights based on results of comparing the output distance values with the actual feed distance values.

The environment data may include at least one of gas concentration, temperature, and humidity inside the feed bin.

The feed management service provision device may further include a feed spoilage degree determination unit configured to calculate a daily feed change amount based on the remaining amount of the feed and determine a spoilage degree of the feed based on the gas concentration, the temperature, the humidity, and the daily feed change amount.

The feed spoilage degree determination unit may calculate a high temperature and high humidity period in which the temperature and the humidity are measured to be higher than a set temperature and a set humidity, respectively, determine the spoilage degree of the feed through a weighted sum of a difference value between a predetermined daily feed feeding amount and the daily feed change amount and the gas concentration when the high temperature and high humidity period exceeds a preset period, and determine the spoilage degree of the feed through a weighted sum of the difference value between the predetermined daily feed feeding amount and the daily feed change amount, the high temperature and high humidity period, and the gas concentration when the high temperature and high humidity period does not exceed the preset period.

The feed management service provision unit may provide feed replenishment notification information and a list of feed companies to the user device when the remaining amount of the feed is less than a first threshold or the spoilage degree of the feed exceeds a second threshold.

The feed management service provision unit may recommend at least one of a replenishment frequency of the feed, a replenishment amount of the feed, and a feed additive on the user device according to the spoilage degree of the feed.

According to one embodiment of the present invention, a method of providing a feed management service that provides a feed management service in conjunction with a measurement device installed inside a feed bin of a farmhouse, includes receiving a feed measurement distance value indicating a distance from the measurement device to feed and environment data inside the feed bin from the measurement device, training an error correction model using a plurality of pieces of training data including a plurality of feed measurement distance values for training collected from a plurality of feed bins, a plurality of pieces of environment data for training, and a plurality of actual feed distance values corresponding to the plurality of feed measurement distance values for training, calculating an error-corrected feed measurement distance value from the feed measurement distance value and the environment data received from the measurement device using the trained error correction model, calculating a remaining amount of the feed based on the error-corrected feed measurement distance value, a volume of the feed bin, and a height of the feed bin, and providing a feed management service to a user device based on the remaining amount of the feed.

### Advantageous Effects

According to embodiments of the present invention, a prediction accuracy of a remaining amount of feed can be increased by learning measured distance values and environment data collected from a plurality of farmhouses and correcting an error in a distance value to the feed, thereby improving the quality of a feed management service.

In addition, according to embodiments of the present invention, a determination accuracy of a spoilage degree of feed can be increased by determining the spoilage degree of the feed using various data related to environment inside a feed bin, thereby improving the quality of a feed management service.

### DESCRIPTION OF DRAWINGS

FIG. 1 is a configuration diagram of a feed management service provision system according to one embodiment of the present invention.

FIG. 2 is a configuration diagram of a feed management service provision device according to one embodiment of the present invention.

FIG. 3 is a diagram for describing a feed measurement distance value according to one embodiment of the present invention.

FIG. 4 is a diagram for describing a process of training an error correction model according to one embodiment of the present invention.

FIG. 5 is a diagram for describing an example of providing a feed management service according to one embodiment of the present invention.

FIG. 6 is a flowchart for describing a method of providing a feed management service according to one embodiment of the present invention.

### MODES OF THE INVENTION

Hereinafter, specific embodiments of the present invention will be described with reference to the accompanying drawings. The following detailed description is provided to assist in a comprehensive understanding of methods, devices and/or systems described in the present invention. However, the detailed description is only for illustrative purposes and the present invention is not limited thereto.

In describing embodiments of the present invention, when it is determined that detailed descriptions of known technology related to the present invention may unnecessarily obscure the gist of the present invention, the detailed descriptions thereof will be omitted. The terms to be described below are defined in consideration of functions in the present invention, but may be changed depending on the customary practice, the intention, or the like, of a user or operator. Thus, the definitions should be determined based on the overall content of the present specification. The terms used in the detailed description are only for describing the embodiments of the present invention, and should not be construed as limitative. Unless expressly used otherwise, a singular expression includes a plural meaning. In the present description, the terms “including”, “comprising,” and the like are used to indicate certain characteristics, numbers, steps, operations, elements, and a portion or combination thereof, but should not be interpreted to preclude existence of possibility of one or more other characteristics, numbers, steps, operations, elements, and a portion or combination thereof.

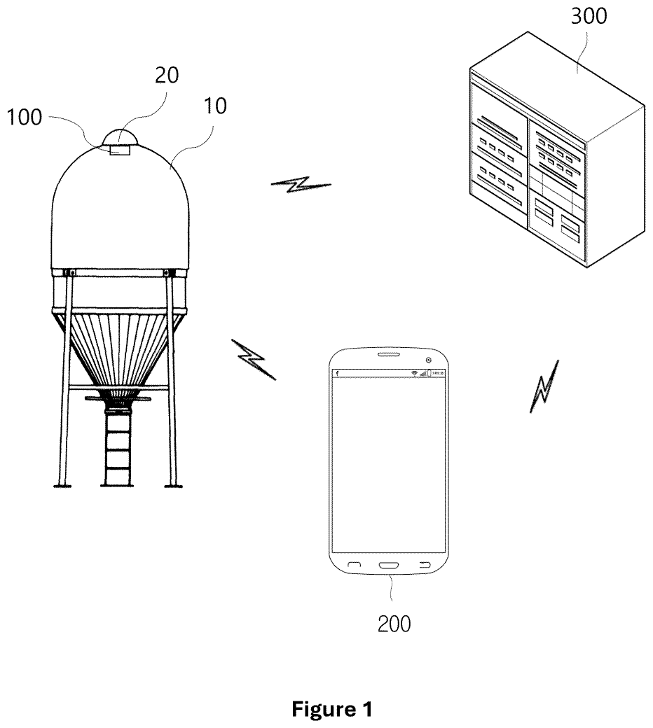

FIG. 1 is a configuration diagram of a feed management service provision system according to one embodiment of the present invention.

Referring to FIG. 1, a feed management service provision system includes a feed bin 10, a measurement device 20, a user device 30, and a feed management service provision device 100.

The feed bin 10 is a tank that stores feed. The type of feed bin 10 may vary depending on the farmhouse. The shape and size of the feed bin 10 may vary, and model information of the feed bin 10 may be managed by the feed management service provision device 100. The feed bin 10 has a lid formed on the top to seal the interior. In this case, the measurement device 20 may be installed inside the lid of the feed bin 10. This is for measuring a distance from an inner center of the feed bin 10 to the feed.

The measurement device 20 is a wireless communication terminal installed inside the feed bin 10. In one embodiment, the measurement device 20 measures a distance from the measurement device 20 to the feed inside the feed bin 10. For this purpose, the measurement device 20 may use a LiDAR sensor that measures a distance to an object using a laser signal, but is not necessarily limited thereto. The measurement device 20 may also measure the distance to feed using an ultrasonic sensor.

Meanwhile, in the present specification, the distance from the measurement device 20 to the feed may be referred to as a feed measurement distance value.

In one embodiment, the measurement device 20 may periodically measure environment data inside the feed bin 10. In this case, the environment data may include gas concentration, temperature, humidity, and the like. For example, the measurement device 20 may measure the temperature and humidity inside the feed bin 10 using a temperature sensor and a humidity sensor. In addition, the measurement device 20 may measure the gas concentration inside the feed bin 10 using a gas detection sensor. In this case, the gas concentration may represent the concentration of ammonia and carbon dioxide.

In one embodiment, the measurement device 20 may communicate with the feed management service provision device 100 using a wireless communication network. For example, the measurement device 20 may communicate with the feed management service provision device 100 using a long range (LoRa) communication network.

In one embodiment, the measurement device 20 may use power using sunlight. In this case, the measurement device 20 may be electrically connected to a solar panel formed on the outside of the feed bin 10. This is for allowing the measurement device 20 to be charged through sunlight without a separate constant power source from the outside in wirelessly communicating with the feed management service provision device 100. In this case, since the measurement device 20 is driven at low power, the measurement device 20 may be driven for a significant period of time even when charged with electricity using sunlight.

In one embodiment, the measurement device 20 may detect a tilt of a body. The measurement device 20 detects the tilt so that a laser signal is not output at a tilt at a center of the feed bin 10. In this case, it is desirable that the LiDAR sensor of the measurement device 20 is designed in a structure capable of adjusting the tilt. The measurement device 20 may change the tilt of the LiDAR sensor when the tilt of the body exceeds a preset value through a horizontal sensor. The measurement device 20 may output the laser signal only when the tilt of the body is within the preset value. Accordingly, it is possible to prevent the feed measurement distance value from being inaccurately collected.

The feed management service provision device 100 provides a feed management service to the user in conjunction with the measurement device 20.

In one embodiment, the feed management service provision device 100 may provide the feed management service based on big data including information related to the farmhouse, information related to the feed bin 10, information related to the feed stored in the feed bin 10, information related to the environment inside the feed bin 10, information related to the feed company, and the like. The information related to the feed bin 10 may include model information about the feed bin 10, the volume of the feed bin 10, the height of the feed bin 10, and the like. The information related to the feed may include a feed measurement distance value, a remaining amount of the feed, a daily feed change amount, a predetermined daily feed feeding amount, replenishment timing of the feed, a replenishment amount of the feed, information on the manufacturer of the feed, types of feed additives, and the like.

In one embodiment, the feed management service provision device 100 communicates with the measurement device 20 to receive the feed measurement distance value and environment data. The feed management service provision device 100 may collect and manage a plurality of feed measurement distance values for training and a plurality of pieces of environment data for training by communicating with a plurality of measurement devices installed in a plurality of feed bins. In this case, a plurality of feed bins may be provided in a plurality of farmhouses.

In one embodiment, the feed management service provision device 100 may predict the remaining amount of the feed stored inside the feed bin 10 based on the feed measurement distance value and environment data. For example, the feed management service provision device 100 may correct an error in the feed measurement distance value using an error correction model and calculate the remaining amount of feed based on the error-corrected feed measurement distance value.

In this case, the error correction model may be an artificial intelligence-based learning model that receives the feed measurement distance value and environment data and outputs the error-corrected feed measurement distance value. For example, the error correction model may be a model for correcting an error that may occur in the distance value measured by the measurement device 20 depending on the environment, such as gas concentration, temperature, humidity, and the like, inside the feed bin 10. The error correction model may be a machine learning-based or deep learning-based learning model, but is not necessarily limited thereto.

In one embodiment, the feed management service provision device 100 may determine the spoilage degree of the feed based on the environment data. For example, the feed management service provision device 100 may determine the spoilage degree of the feed based on a high temperature and high humidity period in which the temperature and the humidity are measured to be higher than a set temperature and a set humidity, respectively, the gas concentration, and the daily feed change amount.

In one embodiment, the feed management service provision device 100 may provide the feed management service to the user device 30 according to the remaining amount of the feed and the spoilage degree of the feed. The feed management service may include various functions related to feed management. For example, the feed management service provision device 100 may notify the user device 30 of feed replenishment based on the remaining amount of the feed or provide a list of feed companies for feed replenishment. In addition, the feed management service provision device 100 may recommend a replenishment frequency of the feed, a replenishment amount of the feed, a feed additive, and the like, on the user device 30 in consideration of the spoilage degree of the feed. Meanwhile, the feed management service may include various services related to feed management in addition to the examples described above.

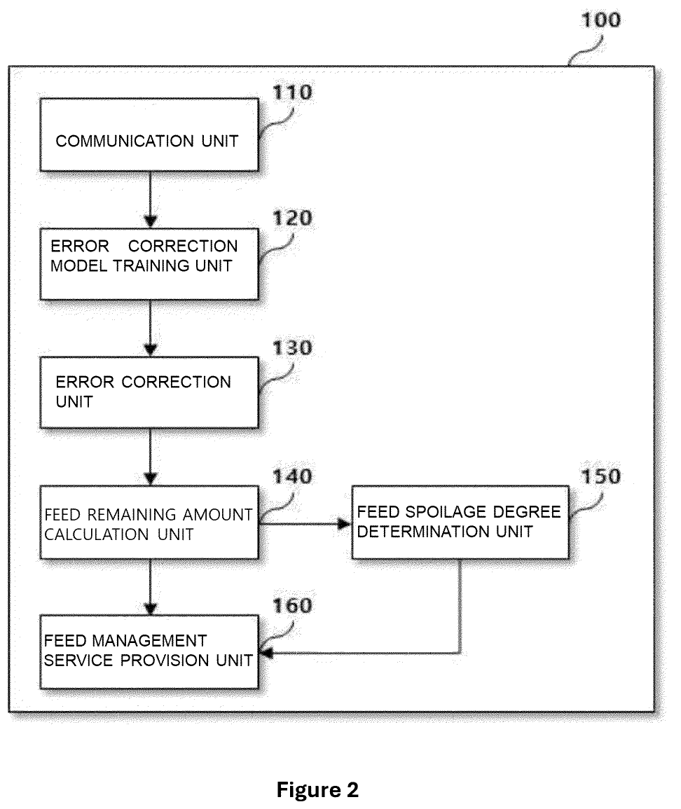

Hereinafter, the feed management service provision device 100 will be described in detail with reference to FIGS. 2 to 5.

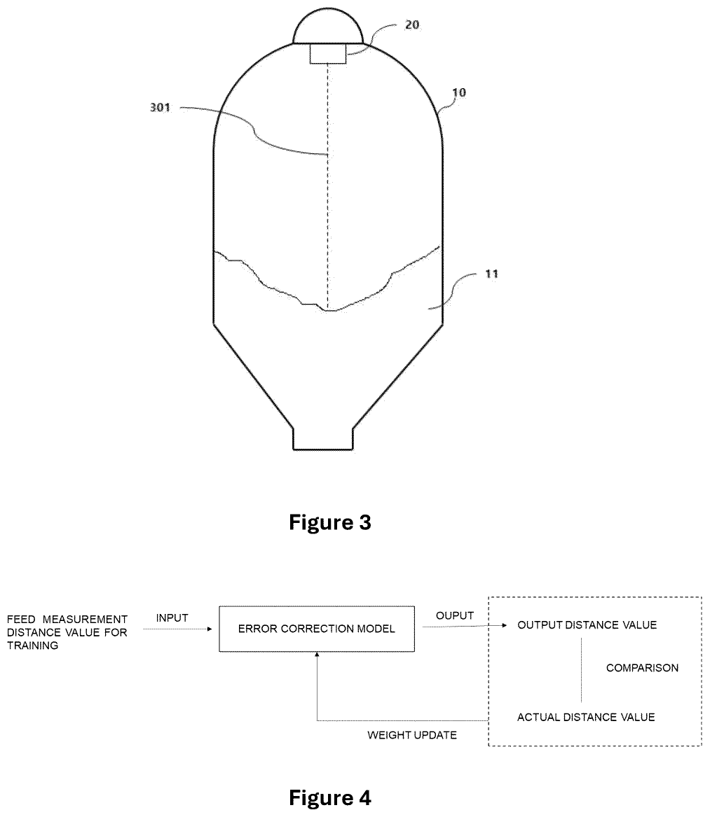

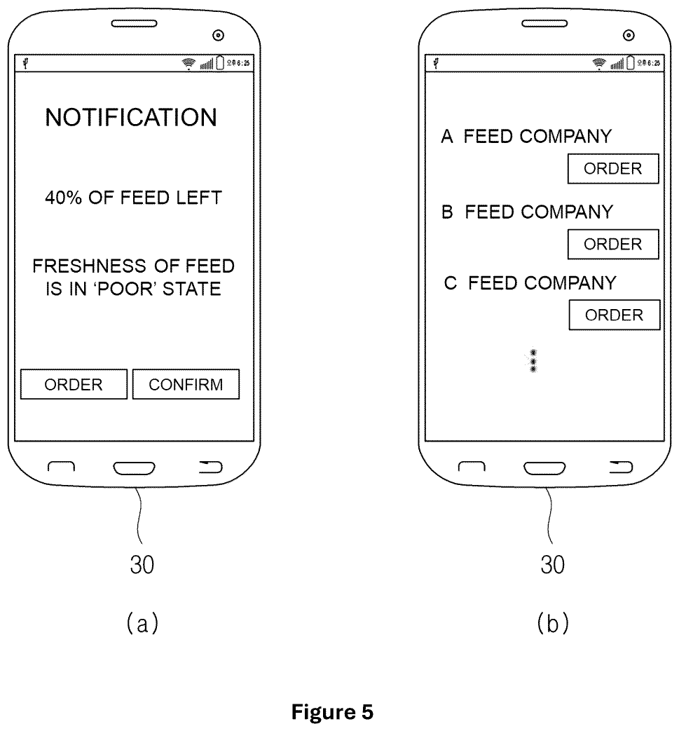

FIG. 2 is a configuration diagram of a feed management service provision device 100 according to one embodiment of the present invention. FIG. 3 is a diagram for describing a feed measurement distance value according to one embodiment of the present invention. FIG. 4 is a diagram for describing a process of training an error correction model according to one embodiment of the present invention. FIG. 5 is a diagram for describing an example of providing a feed management service according to one embodiment of the present invention.

Referring to FIG. 2, the feed management service provision device 100 may include a communication unit 110, an error correction model training unit 120, an error correction unit 130, a feed remaining amount calculation unit 140, a feed spoilage degree determination unit 150, and a feed management service provision unit 160.

The communication unit 110 communicates with an external measurement device 20. For example, the communication unit 110 may wirelessly communicate, such as LoRa communication, but is not necessarily limited thereto. The communication unit 110 may receive a feed measurement distance value indicating a distance from the measurement device 20 to the feed and environment data inside a feed bin 10 from the measurement device 20 every preset time period.

Referring to FIG. 3, the measurement device 20 may measure a feed measurement distance value 301, which represents a distance from the measurement device 20 to a feed 11. For example, the measurement device 20 may transmit a laser signal through a LiDAR sensor and measure the feed measurement distance value 301 by receiving the laser signal reflected from a surface of the feed 11 and returned. Then, the communication unit 110 may receive the feed measurement distance value from the measurement device 20. In addition, the communication unit 110 may periodically receive gas concentration, temperature, humidity, and the like, inside the feed bin 10 from the measurement device 20.

Referring again to FIG. 2, the error correction model training unit 120 may train the error correction model using a plurality of pieces of training data. In this case, the plurality of pieces of training data may include a plurality of feed measurement distance values for training collected from a plurality of feed bins, a plurality of pieces of environment data for training, and a plurality of actual feed distance values corresponding to the plurality of feed measurement distance values for training.

The actual feed distance value may represent an actual distance from the measurement device 20 to the feed. In one embodiment, the actual feed distance value may be a distance when the feed reaches a certain height, such as ¼ point, ½ point, or the like, within the feed bin 10. In addition, the actual feed distance value may be a distance directly measured by a user of a corresponding farmhouse. In this case, the feed measurement distance value for training may be a distance measured by the measurement device 20 at a point in time when a corresponding actual feed distance value is obtained. Meanwhile, a method of obtaining the actual feed distance value is not limited to the above-described example, and the actual feed distance value may be obtained through various methods.

In one embodiment, the error correction model training unit 120 may receive the plurality of feed measurement distance values for training and the plurality of pieces of environment data for training and train the error correction model to output distance values that are close to the plurality of actual feed distance values. For example, the error correction model may be trained in a manner of outputting distance values by receiving the feed measurement distance values for training and the pieces of environment data for training, and updating weights based on results of comparing the output distance values with the actual feed distance values.

In one embodiment, the error correction model may be constructed as a neural network including a plurality of layers. For the neural network, artificial neurons implemented by simplifying the functions of biological neurons may be used, and artificial neurons may be interconnected through connection lines with connection weights. The connection weight, which is a parameter of the neural network, is a specific value of the connection line and may also be expressed as connection strength. The neural network may perform human cognitive activities or learning processes through artificial neurons. The artificial neuron may also be referred to as a node.

The neural network may include a plurality of layers. For example, the neural network may include an input layer, a hidden layer, and an output layer. The input layer may receive input to perform learning and transmit the input to the hidden layer, and the output layer may generate output of the neural network based on signals received from nodes of the hidden layer. The hidden layer is positioned between the input layer and the output layer, and may change training data transmitted through the input layer into values that are easy to predict. Nodes included in the input layer and the hidden layer may be connected to each other through connection lines with connection weights, and nodes included in the hidden layer and the output layer may also be connected to each other through connection lines with connection weights. The input layer, the hidden layer, and the output layer may include a plurality of nodes.

Hereinafter, training the neural network may be understood as learning the parameters of the neural network. In addition, the trained neural network may be understood as a neural network to which learned parameters are applied. The neural network may be trained using a preset loss function as an indicator. The loss function may be an indicator for the neural network to determine optimal weight parameters through training. The neural network may be trained with the goal of minimizing a resulting value of a set loss function.

Referring to FIG. 4, the error correction model may be trained using a feed measurement distance value for training and environment data for training data and using an actual feed distance values corresponding to the feed measurement distance value for training as target data. In this case, the feed measurement distance value for training, the environment data for training, and the actual feed distance value used in one learning cycle may be data measured at the same point in time in the same feed bin 10.

Specifically, the error correction model may receive the feed measurement distance value for training and the environment data for training and output an output distance value according to a stored weight. Then, the error correction model may update the weight through a result of comparing the output distance value with the actual feed distance value. For example, the error correction model may update the weight so that a resulting value of the loss function for the output distance value and the actual feed distance value becomes smaller.

Referring again to FIG. 2, the error correction unit 130 may calculate an error-corrected feed measurement distance value from the feed measurement distance value and the environment data received by the communication unit 110 using the trained error correction model.

The feed remaining amount calculation unit 140 may calculate a remaining amount of the feed based on the error-corrected feed measurement distance value and information related to the feed bin 10. For example, the feed remaining amount calculation unit 140 may calculate the height of the feed based on the error-corrected feed measurement distance value and the height of the feed bin 10. In this case, the height of the feed may represent the length from the bottom of the feed bin 10 to the surface of the feed. The feed remaining amount calculation unit 140 may calculate the remaining amount of the feed based on the volume of the feed bin 10 and the height of the feed.

Therefore, according to embodiments of the present invention, the remaining amount of the feed may be accurately calculated by correcting an error in the feed measurement distance value through a model trained using training data collected from a plurality of farmhouses.

Meanwhile, the feed spoilage degree determination unit 150 may calculate the daily feed change amount based on the remaining amount of the feed and determine the spoilage degree of the feed based on the gas concentration, temperature and humidity inside the feed bin 10, and the daily feed change amount.

In one embodiment, the feed spoilage degree determination unit 150 may calculate the daily feed change amount based on the remaining amount of the feed measured every day. In this case, the daily feed change amount is information corresponding to an amount of daily feed intake consumed by livestock in a farmhouse, and may be information used to determine the spoilage degree of the feed. The amount of feed consumed by livestock may vary depending on the freshness of the feed. For example, when the freshness of the feed is high, the amount of daily feed intake of livestock may correspond to a daily feed feeding amount predetermined according to a growth period of the livestock. However, as the spoilage degree of the feed increases, the freshness of the feed decreases, and the amount of daily feed intake of livestock may become less than the predetermined daily feed feeding amount. Therefore, when the daily feed change amount decreases or becomes less than the predetermined daily feed feeding amount, it may be determined that the feed is spoiled.

In one embodiment, the feed spoilage degree determination unit 150 may calculate a high temperature and high humidity period in which the temperature and humidity inside the feed bin 10 are measured to be higher than a set temperature and a set humidity, respectively. For example, the feed spoilage degree determination unit 150 may calculate a period in which the temperature inside the feed bin 10 is 30 degrees or higher and the humidity therein is 70% or higher as the high temperature and high humidity period. However, the above-mentioned set temperature and humidity are only examples and are not necessarily limited thereto.

In one embodiment, the feed spoilage degree determination unit 150 may determine that the feed is spoiled when the high temperature and high humidity period exceeds a preset period. In this case, the preset period may be set to two weeks, but is not necessarily limited thereto. In addition, when the high temperature and high humidity period exceeds the preset period, the feed spoilage degree determination unit 150 may determine the spoilage degree of the feed through a weighted sum of a difference value between the predetermined daily feed feeding amount and the daily feed change amount and the gas concentration. In this case, the spoilage degree of the feed may be calculated through Equation 1 below.

$$C = k 1 * G + k 2 ( F 1 - F 2 ) \qquad [ Equation 1 ]$$

In Equation 1 above, C is a spoilage degree of the feed, G may be a gas concentration, F1 may be a predetermined daily feed feeding amount, F2 may be a daily feed change amount, k1 may be a weight constant applied to the gas concentration, and k2 may be a weight constant applied to the difference value between the predetermined daily feed feeding amount and the daily feed change amount.

In one embodiment, when the high temperature and high humidity period does not exceed the preset period, the feed spoilage degree determination unit 150 may determine the spoilage degree of the feed through a weighted sum of the difference value between the predetermined daily feed feeding amount and the daily feed change amount, the high temperature and high humidity period, and the gas concentration. In this case, the spoilage degree of the feed may be calculated through Equation 2 below.

$$C = k 3 * P + k 4 * G + k 5 ( F 1 - F 2 ) \qquad [ Equation 2 ]$$

In Equation 2 above, P may be the high temperature and high humidity period, k3 may be a weight constant applied to the high temperature and high humidity period, k4 may be a weight constant applied to the gas concentration, and k5 may be a weight constant applied to the difference value between the predetermined daily feed feeding amount and the daily feed change amount. Specifically, as the high temperature and high humidity period becomes longer or the gas concentration increases, the spoilage degree of the feed may increase. In addition, as the difference value between the daily feed change amount and the predetermined daily feed feeding amount increases, the spoilage degree of the feed may increase.

Therefore, according to embodiments of the present invention, a determination of regarding the spoilage degree of the feed may be improved by determining the spoilage degree of the feed by comprehensively considering various information related to the environment inside the feed bin 10.

Meanwhile, the feed management service provision unit 160 may provide the feed management service to the user device 30 based on at least one of the remaining amount of the feed and the spoilage degree of the feed.

In one embodiment, the feed management service provision unit 160 may provide feed replenishment notification information and a list of feed companies to the user device 30 when the remaining amount of the feed is less than a first threshold or the spoilage degree of the feed exceeds a second threshold.

Referring to FIG. 5, (a) illustrates an example of feed replenishment notification information, and (b) illustrates an example of a list of feed companies. The feed replenishment notification information may include the remaining amount of the feed and the spoilage degree of the feed. The list of feed companies may include information related to the feed companies, such as the type of feed provided by each feed company, a feed additive, an address, contact information, and the like. The user may replenish feed through the user device 30 by considering the feed replenishment notification information and the list of feed companies.

In one embodiment, the feed management service provision unit 160 may recommend at least one of a replenishment frequency of the feed, a replenishment amount of the feed, a feed additive, and the like, on the user device 30 according to the spoilage degree of the feed.

For example, the feed management service provision unit 160 may determine that the rate of spoilage of the feed is high when the spoilage degree of the feed is high based on a point in time when the feed is replenished in the feed bin 10. In this case, the feed management service provision unit 160 may recommend increasing the replenishment frequency of the feed and reducing the replenishment amount of the feed on the user device 30. That is, by recommending a user to replenish small amounts of feed at short intervals in an environment where the rate of spoilage is high, livestock may be provided with highly fresh feed. In addition, the feed management service provision unit 160 may recommend a feed additive that slows down the rate of spoilage of the feed and has a high effect of maintaining freshness on the user device 30.

For another example, the feed management service provision unit 160 may determine that the rate of spoilage of the feed is low when the spoilage degree of the feed is low based on the point in time when the feed is replenished in the feed bin 10. In this case, the feed management service provision unit 160 may recommend reducing the replenishment frequency of the feed and increasing the replenishment amount of the feed on the user device 30. That is, by recommending the user to replenish large amounts of feed at long intervals in an environment where the rate of spoilage is low, the cost required each time to replenish feed may be reduced.

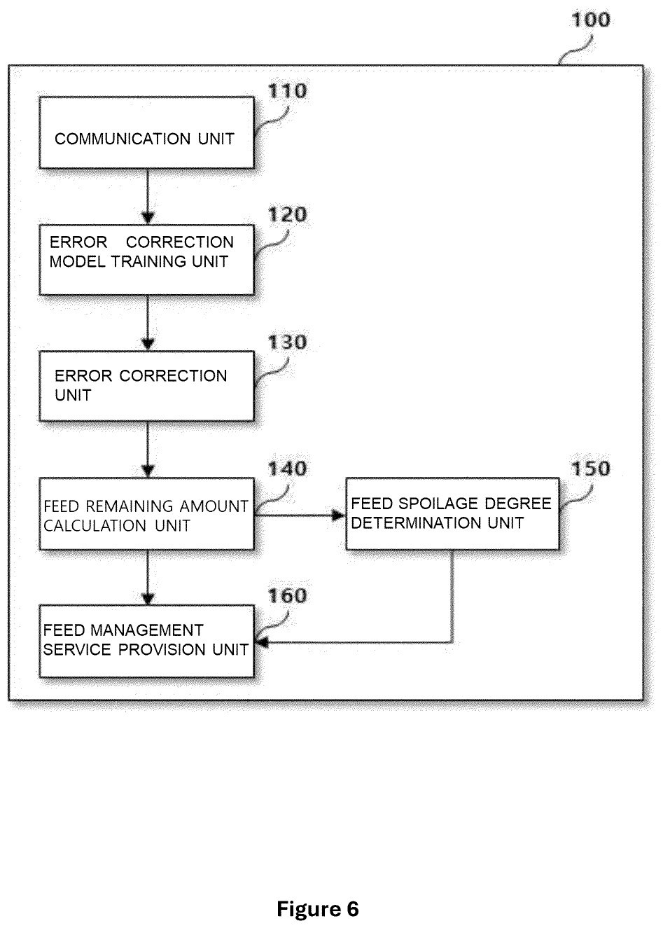

FIG. 6 is a flowchart for describing a method of providing a feed management service according to one embodiment of the present invention.

The method illustrated in FIG. 6 may be performed, for example, by the feed management service provision device 100 illustrated in FIG. 1.

Referring to FIG. 6, in step S601, the feed management service provision device 100 may receive a feed measurement distance value and environment data inside the feed bin 10 from the measurement device 20.

In step S603, the feed management service provision device 100 may train an error correction model using a plurality of pieces training data. In this case, the plurality of pieces of training data may include a plurality of feed measurement distance values collected from a plurality of feed bins, a plurality of pieces of environment data, and a plurality of actual feed distance values corresponding to the plurality of feed measurement distance values.

In step S605, the feed management service provision device 100 may calculate an error-corrected feed measurement distance value from the feed measurement distance value and environment data using the trained error correction model.

In step S607, the feed management service provision device 100 may calculate a remaining amount of feed based on the error-corrected feed measurement distance value and information related to the feed bin 10.

In step S609, the feed management service provision device 100 may provide a feed management service to the user device 30 based on the remaining amount of feed.

Although the representative embodiments of the present invention have been described in detail as above, those skilled in the art will understand that various modifications may be made thereto without departing from the scope of the present invention. Therefore, the scope of rights of the present invention should not be limited to the described embodiments, but should be defined not only by the claims set forth below but also by equivalents of the claims.

### REFERENCE SIGNS LIST

10: Feed bin
20: Measurement device
30: User device
100: Feed management service provision device

1. A feed management service provision device that provides a feed management service in conjunction with a measurement device installed inside a feed bin of a farmhouse, comprising:
a communication unit configured to receive a feed measurement distance value indicating a distance from the measurement device to feed and environment data inside the feed bin from the measurement device;
an error correction model training unit configured to train an error correction model using a plurality of pieces of training data including a plurality of feed measurement distance values for training collected from a plurality of feed bins, a plurality of pieces of environment data for training, and a plurality of actual feed distance values corresponding to the plurality of feed measurement distance values for training;
an error correction unit configured to calculate an error-corrected feed measurement distance value from the feed measurement distance value and the environment data received by the communication unit using the trained error correction model;
a feed remaining amount calculation unit configured to calculate a remaining amount of the feed based on the error-corrected feed measurement distance value and information related to the feed bin; and
a feed management service provision unit configured to provide a feed management service to a user device based on the remaining amount of the feed.

2. The feed management service provision device of claim 1, wherein the error correction model training unit receives the plurality of feed measurement distance values for training and the plurality of pieces of environment data for training and trains the error correction model to output distance values that are close to the plurality of actual feed distance values.

3. The feed management service provision device of claim 2, wherein the error correction model is trained in a manner of outputting distance values by receiving the feed measurement distance values for training and the pieces of environment data for training, and updating weights based on results of comparing the output distance values with the actual feed distance values.

4. The feed management service provision device of claim 1, wherein the environment data includes at least one of gas concentration, temperature, and humidity inside the feed bin.

5. The feed management service provision device of claim 4, further comprising a feed spoilage degree determination unit configured to calculate a daily feed change amount based on the remaining amount of the feed and determine a spoilage degree of the feed based on the gas concentration, the temperature, the humidity, and the daily feed change amount.

6. The feed management service provision device of claim 5, wherein the feed spoilage degree determination unit calculates a high temperature and high humidity period in which the temperature and the humidity are measured to be higher than a set temperature and a set humidity, respectively, determines the spoilage degree of the feed through a weighted sum of the gas concentration and the daily feed change amount when the high temperature and high humidity period exceeds a preset period, and determines the spoilage degree of the feed through a weighted sum of the high temperature and high humidity period, the gas concentration, and the daily feed change amount when the high temperature and high humidity period does not exceed the preset period.

7. The feed management service provision device of claim 6, wherein the feed management service provision unit provides feed replenishment notification information and a list of feed companies to the user device when the remaining amount of the feed is less than a first threshold or the spoilage degree of the feed exceeds a second threshold.

8. The feed management service provision device of claim 7, wherein the feed management service provision unit recommends at least one of a replenishment frequency of the feed, a replenishment amount of the feed, and a feed additive on the user device according to the spoilage degree of the feed.

9. A method of providing a feed management service that provides a feed management service in conjunction with a measurement device installed inside a feed bin of a farmhouse, comprising:
receiving a feed measurement distance value indicating a distance from the measurement device to feed and environment data inside the feed bin from the measurement device;
training an error correction model using a plurality of pieces of training data including a plurality of feed measurement distance values for training collected from a plurality of feed bins, a plurality of pieces of environment data for training, and a plurality of actual feed distance values corresponding to the plurality of feed measurement distance values for training;
calculating an error-corrected feed measurement distance value from the feed measurement distance value and the environment data received from the measurement device using the trained error correction model;
calculating a remaining amount of the feed based on the error-corrected feed measurement distance value, a volume of the feed bin, and a height of the feed bin; and
providing a feed management service to a user device based on the remaining amount of the feed.
